(19) United States
(12) Patent Application Publication
(10) Pub. No.: US 2005/0205707 A1
(43) Pub. Date: Sep. 22, 2005

(54) Tape reel assembly with microcellular foam hub

(75) Inventors: Jason D. Hanzlik, Wahpeton, ND (US); Michael E. Reard, Fergus Falls, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 10/801,285

(22) Filed: Mar. 16, 2004

(51) Int. Cl. G11B 23/107; B65H 75/14

(52) U.S. Cl. 242/348; 242/610.6

(57) ABSTRACT

A tape reel assembly for use in a tape drive system for winding and unwinding storage tape is disclosed. The tape reel assembly includes a plastic hub that defines a tape winding surface. In this regard, the hub is formed of microcellular foam.

### THE FIELD OF THE INVENTION

The present invention relates to a tape reel assembly for use in a tape drive system. More particularly, it relates to a tape reel assembly having a microcellular foam hub.

### BACKGROUND OF THE INVENTION

Data storage tape systems have been used for decades in the computer, audio, and video fields. The data storage tape system includes a tape drive and one or more data storage tape cartridges. During use, tape from the cartridge is driven by a tape drive system defined by one or both of the cartridge and tape drive. Regardless of exact form, the data storage tape system continues to be a popular format for recording large volumes of information for subsequent retrieval and use.

With the above in mind, a data storage tape cartridge generally consists of an outer shell or housing maintaining at least one tape reel assembly and a length of magnetic storage tape. The storage tape is wrapped about a hub of the tape reel assembly and is driven through a defined path by a driving system. The housing normally includes a separate cover and a separate base. Together, the cover and the base form an opening (or window) at a forward portion of the housing permitting access to the storage tape by a read/write head upon insertion of the data storage tape cartridge into the tape drive. The interaction between the storage tape and head can occur within the housing (i.e., a mid-tape load design) or exterior to the housing (i.e., a helical drive design). Where the head/storage tape interaction is exterior to the housing, the data storage tape cartridge normally includes a single tape reel assembly employing a leader block. Alternately, where the head/storage tape interaction is within the housing, a dual tape reel configuration is typically employed.

Regardless of the number of tape reel assemblies associated with a particular data storage tape cartridge, the tape reel assembly (also known as a spool) is generally comprised of three elements: an upper flange, a lower flange, and the hub. In general, the hub includes a core that defines a tape winding surface. The flanges are optional, and if employed, are disposed at opposite ends of the hub and spaced apart to accommodate a width of the storage tape. To reduce the likelihood of the storage tape undesirably contacting one of the flanges during a winding operation, the flange-to-flange spacing is selected to be slightly greater than the width of the tape.

The spool is a repository for the storage tape. In particular, the storage tape is wrapped onto the tape winding surface. In this regard, surface variations on the tape winding surface affect the winding of the storage tape. In particular, wavy variations on the tape winding surface can cause significant lateral storage tape movement and deleterious storage tape tension gradients.

In addition, winding successive layers of storage tape onto the hub creates a compressive force that will eventually cause the tape winding surface to deflect radially inward (i.e., deform). Unfortunately, many prior art hubs have tape winding surfaces that deform in a non-uniform manner. In particular, the prior art hubs have inadequately accounted for the distribution of the compressive force arising from the wrapped storage tape. Unequal distribution of the compressive forces can cause the deformation of the prior art tape winding surfaces to vary widely, deflecting more near the upper flange, for instance, and less near the lower flange (or vice versa). The consequences of non-uniform deformation of the tape winding surface include large lateral storage tape movement and high tension gradients across the storage tape, resulting in a poor head-to-tape interface. These undesirable consequences can be manifested in tape reel assemblies employed in both data storage tape cartridges and tape drives (where the hubs are known as take-up reels), and can lead to undesirable read/write errors in the data storage tape system.

Tape reel assemblies are typically molded from plastic. Though cost effective, plastic hubs can have wavy tape winding surfaces and can deform non-uniformly under the compressive forces associated with successive windings of storage tape. Manufacturers of prior art hubs have struggled to minimize these inter-related characteristics. Specifically, reinforcing the hub to increase its stiffness is known to result in an increase in the waviness of the tape winding surface. In particular, reinforced hubs can exhibit a molding sink in the reinforced region that directly increases the waviness of the tape winding surface. Alternately, reducing the waviness of the tape winding surface, for example by skiving the wavy portion of the plastic at the surface, can result in a reduction in hub stiffness.

Tape reel assemblies will continue to be employed in tape drives and data storage tape cartridges. With increasing speeds of reading/writing and advanced magnetic tape technology, design of the tape reel assembly is directed to providing accurate and consistent storage tape positioning. To this end, flexible hubs having wavy tape winding surfaces can result in lateral movement of the storage tape, creating errors in reading from, and writing to, the storage tape. Therefore, a need exists for a tape reel assembly with a stiffer, deformation resistant hub having a uniformly straight tape winding surface.

### SUMMARY OF THE INVENTION

One aspect of the present invention relates to a tape reel assembly for use in a tape drive system for winding and unwinding storage tape. The tape reel assembly includes a plastic hub that defines a tape winding surface. In this regard, the hub is formed of microcellular foam.

Another aspect of the present invention relates to a data storage tape cartridge. The data storage tape cartridge includes a housing defining an enclosed region, at least one tape reel assembly rotatably disposed within the enclosed region, and a storage tape. In particular, the tape reel assembly includes a hub defining a tape winding surface such that the storage tape is wound about the tape winding surface. In this regard, the hub is formed from a microcellular foam.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a perspective, exploded view of a single reel data storage tape cartridge showing a tape reel assembly;

FIG. 2 is an exploded view of a three-piece tape reel assembly including a hub according to one embodiment of the present invention;

FIG. 3 is a cross-sectional view of the hub shown in FIG. 2;

FIG. 4 is a plan view of the hub shown in FIG. 2;

FIG. 5 is a perspective view of an alternate tape reel assembly in accordance with one embodiment of the present invention; and

FIG. 6 is a cross-sectional view of a hub portion of the tape reel assembly shown in FIG. 5.

### DETAILED DESCRIPTION OF THE PREFERRED EMBODIMENTS

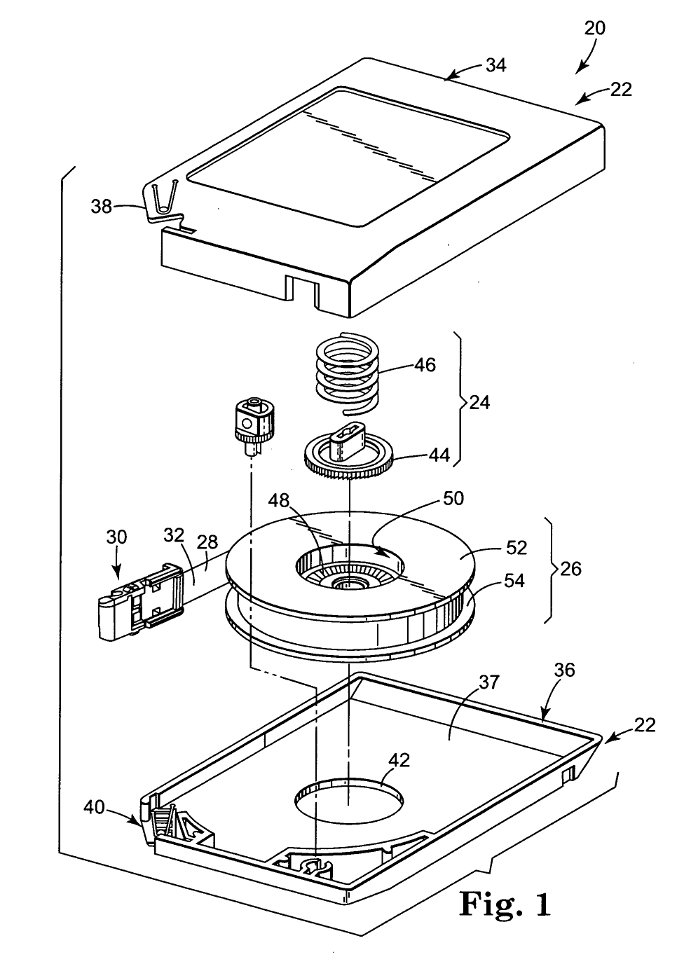

The present invention relates to a tape reel assembly useful as part of a tape drive system component, such as a data storage tape cartridge or a tape drive. To this end, an exemplary single reel data storage tape cartridge according to one embodiment of the present invention is illustrated at 20 in FIG. 1. Generally, the data storage tape cartridge 20 includes a housing 22, a brake assembly 24, a tape reel assembly 26, a storage tape 28, and a leader block 30. The tape reel assembly 26 is disposed within the housing 22. The storage tape 28, in turn, is wound about the tape reel assembly 26 and includes a leading end 32 attached to the leader block 30. As a point of reference, while a single reel data storage tape cartridge 20 is shown, the present invention is equally applicable to other cartridge configurations, such as a dual reel cartridge.

The housing 22 is sized to be received by a typical tape drive (not shown). Thus, the housing 22 exhibits a size of approximately 125 mm×110 mm×21 mm, although other dimensions are equally acceptable. With this in mind, the housing 22 is defined by a first housing section 34 and a second housing section 36. In one embodiment, the first housing section 34 forms a cover whereas the second housing section 36 forms a base. As used throughout the specification, directional terminology such as “cover,” “base,” “upper,” “lower,” “top,” “bottom,” etc., is employed for purposes of illustration only and is in no way limiting.

The first and second housing sections 34 and 36, respectively, are sized to be reciprocally mated to one another to form an enclosed region 37 and are generally rectangular, except for one corner 38 that is preferably angled and forms a tape access window 40. The tape access window 40 serves as an opening for the storage tape 28 to exit from the housing 22 such that the storage tape 28 can be threaded to a tape drive (not shown) when the leader block 30 is removed from the tape access window 40. Conversely, when the leader block 30 is stowed in the tape access window 40, the tape access window 40 is covered.

In addition to forming a portion of the tape access window 40, the second housing section 36 also forms a central opening 42. The central opening 42 facilitates access to the tape reel assembly 26 by a drive chuck portion of the tape drive (not shown). During use, the drive chuck portion disengages the brake assembly 24 prior to rotating the tape reel assembly 26 for access to the storage tape 28. The brake assembly 24 is of a type known in the art and generally includes a brake 44 and a spring 46 co-radially disposed within the tape reel assembly 26. When the data storage tape cartridge 20 is idle, the brake assembly 24 engages with a brake interface 48 to selectively “lock” the single tape reel assembly 26 to the housing 22.

The storage tape 28 is preferably a magnetic tape of a type commonly known in the art. For example, the storage tape 28 may consist of a balanced polyethylene naphthalate (PEN) based material coated on one side with a layer of magnetic material dispersed within a suitable binder system and coated on the other side with a conductive material dispersed within a suitable binder system. Acceptable magnetic tape is available, for example, from Imation Corp. of Oakdale, Minn.

The leader block 30 covers the tape access window 40 and facilitates retrieval of the storage tape 28. In general terms, the leader block 30 is shaped to conform to the window 40 of the housing 22 and to cooperate with the tape drive (not shown) by providing a grasping surface for the tape drive to manipulate in delivering the storage tape 28 to the read/write head. In this regard, the leader block 30 can be replaced by other components, such as a dumbbell shaped pin. Moreover, the leader block 30, or a similar component, can be eliminated entirely, such as with a dual reel cartridge design.

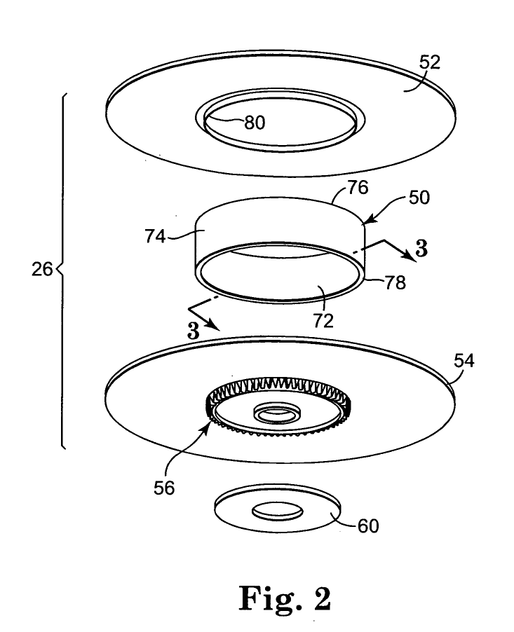

The present invention, as more fully described below, can be beneficially employed in data storage tape cartridges (having either single or multiple tape reel assemblies) and in tape drives having take-up reels. With this in mind, and with reference to FIG. 1, the tape reel assembly 26 comprises a hub 50, an upper flange 52, and a lower flange 54. The upper and lower flanges 52, 54 extend in a radial fashion from opposing sides of the hub 50, respectively. In one embodiment, the hub 50 and the flanges 52, 54 cooperate to retain multiple wraps of the storage tape 28 around the hub 50 and between the flanges 52, 54. Notably, where the cartridge 20 is a belt driven design, the opposing flanges 52, 54 are not necessary to maintain the storage tape 28, and can, therefore, be eliminated. In the broadest sense then, the tape reel assembly 26 can comprise the hub 50 alone. The tape reel assembly 26 is more completely described with reference to FIG. 2 below.

FIG. 2 is an exploded view of the tape reel assembly 26 shown in FIG. 1. The tape reel assembly 26 includes the hub 50 positioned between the upper flange 52 and the lower flange 54. As illustrated, the lower flange 54 includes driven teeth 56. In one embodiment, the tape reel assembly 26 further includes a metallic washer 60. The lower flange 54 can be molded about the washer 60, or the washer 60 can be separately assembled to the lower flange 54. Regardless, the washer 60 is adapted to magnetically couple the tape reel assembly 26 to a magnet within the tape drive (not shown). In an alternate embodiment, the washer 60 is not utilized, such that the hub 50 and the flanges 52, 54, define the tape reel assembly 26.

The hub 50 defines an interior surface 72 and a tape winding surface 74. The tape winding surface 74 is configured for acceptance of the data storage tape 28 (FIG. 1). In this regard, the tape winding surface 74 extends between a first end 76 and a second end 78 of the hub 50. The upper flange 52 couples to the first end 76 of the hub 50 via a first interior edge 80. The lower flange 54 couples to the second end 78 of the hub 50 via a second interior edge (not visible in the view of FIG. 2).

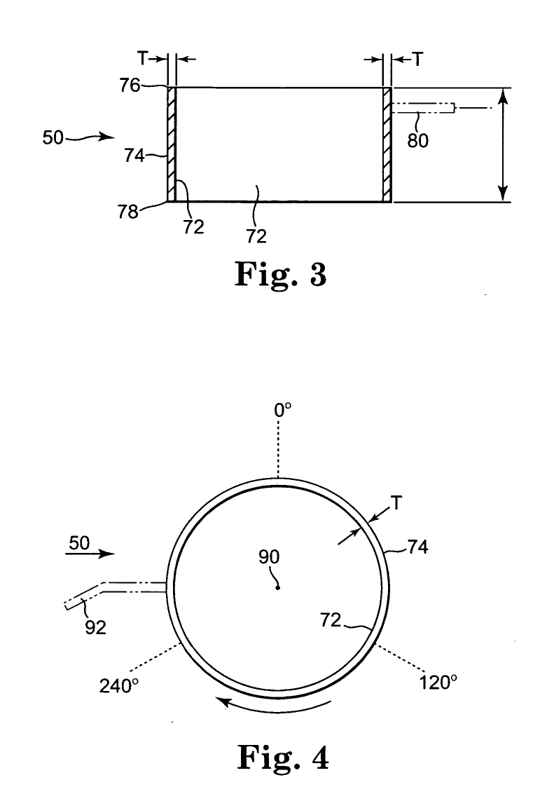

FIG. 3 is a cross-sectional view of the hub 50. The hub 50 has a thickness T defined as the distance between the interior surface 72 and the tape winding surface 74. It is desired that the hub 50 be thick and that the tape winding surface 74 be straight. With this in mind, a waviness measurement is made to quantify the waviness of the tape winding surface 74, as described more fully below.

FIG. 4 is a plan view of the hub 50 illustrating a central axis 90. It is desired that the hub 50 be concentric such that the tape winding surface 74 is everywhere equidistant from the axis 90. In this regard, a radial total indicator run-out measurement is made to gauge the concentricity of the tape winding surface 74, as more fully described below.

The hub 50 according to one embodiment of the present invention is plastic and formed of microcellular foam. Microcellular foam can be produced by dissolving a high concentration of a blowing agent (e.g., an inert gas) into a polymer at a high temperature and under a high pressure, for example, in an extruder, or an injection molding press. Under these conditions, the polymer is super-saturated by the blowing agent and a single phase solution of polymer and blowing agent is formed (in this state the single phase solution is said to be a “supercritical” fluid). As this single phase solution exits the extruder (or the injection molding press) to the atmosphere, the single phase solution experiences a drop in local pressure, and the blowing agent precipitates out of the polymer in the form of gas, thus “foaming” the polymer. The precipitation of the gas forms minute bubbles that reside in the polymer; as the polymer solidifies, the gas bubbles become “cells” in the foam structure. The formation of the cells is called cell nucleation. With the proper mixing and mass flow metering of the single phase solution, a homogeneous nucleation of cells in the polymer is possible. Auxiliary equipment known as a MuCell® system is available from Trexel, Inc., Woburn, Mass., that will convert standard extruders and injection molding processes into microcellular foaming processes having the proper mixing and mass flow metering and capable of achieving the desired homogeneous nucleation of cells.

Microcellular foam is characterized by a high cell nucleation rate that is much greater than the diffusion rate of the blowing agent into the polymer. Under these special conditions, an extremely large number of uniform cells form (cell nucleation) in the polymer before the cell size begins to increase (caused by the blowing agent diffusing into the polymer). Utilization of the MuCell® system (or other like-systems) ensures the process will have the proper mixing and metering of the single phase solution during foam formation. The result is a polymer imbued with millions upon millions of microscopic, uniform cells; i.e., a polymer foam. The foam is characterized by low weight, high strength-to-weight ratio, and high stiffness.

In one embodiment, the hub 50 is formed of a microcellular foam made from a single phase solution of a blowing agent and a polymer. The blowing agent can be any inert gas, preferably carbon dioxide or nitrogen. The polymer can be any polymer that will go into solution with the blowing agent at elevated temperatures and pressures. Suitable polymers for forming microcellular foam include, but are not limited to, polycarbonate, glass-filled polycarbonate, carbon-filled polycarbonate, styrene acrylonitrile, polystyrene, acrylonitrile butadiene styrene, acetal, nylon, poly-ether-ether-ketone, polyetheramide (for example, ULTEM® polyetheramide available from GE Plastics, Pittsfield, Mass.), polypropylene, polyethylene, and polyester. For example, the suitable polymers can be combined with nitrogen as the blowing agent to create a single phase solution in an injection molding process (e.g., a MuCell® system) that will form microcellular polycarbonate foam, microcellular glass-filled polycarbonate foam, microcellular carbon-filled polycarbonate foam, microcellular styrene acrylonitrile foam, microcellular polystyrene foam, microcellular acrylonitrile butadiene styrene foam, microcellular acetal foam, microcellular nylon foam, microcellular poly-ether-ether-ketone foam, microcellular polyetheramide foam, microcellular polypropylene foam, microcellular polyethylene foam, and microcellular polyester foam. In a preferred embodiment, the hub 50 is formed in an injection molding process utilizing 20% glass-filled polycarbonate as the polymer and nitrogen as the blowing agent. The resulting plastic hub 50 is a microcellular glass-filled polycarbonate foam hub having an average cell size of between 5 and 50 micrometers.

Plastic hubs 50 formed of microcellular foam utilizing the above-described process can be thicker than conventional hubs, and yet the tape winding surface 74 does not exhibit the deleterious molding sinks associated with reinforced conventional hubs. It has been surprisingly found that the highly straight hub 50 can be approximately 50% thicker, which results in a stiffer hub 50 that is capable of resisting deformation due to the winding of the storage tape 28 (FIG. 1). In addition, the inventive plastic hubs 50 are lighter in weight by virtue of the homogeneous dispersion of the cells inherent to microcellular foam. Further, it has been discovered that the tape winding surface 74 of the plastic hubs 50 formed of microcellular foam is both straighter and more concentric than conventional plastic hubs. In one embodiment, the thickness T of the hub 50 is between 0.05 to 0.2 inch, more preferably the thickness T is between 0.07 to 0.125 inch, and most preferably the thickness T of the hub 50 is approximately 0.1 inch.

In an alternate embodiment, the upper flange 52 and the lower flange 54 (FIG. 2) are formed of microcellular foam utilizing the above-described process, such that each of the hub 50 and the flanges 52, 54 are formed of microcellular foam.

Straightness of the tape winding surface 74 can be quantified by measuring total waviness (WT). The WT is quantified via a waviness probe 80 shown in ghost outline in FIG. 3. For example, the waviness probe 80 can be an SV-3000 contact probe available from Mitutoyo Measurement Technology, Warwick, U.K. The waviness probe 80 is capable of measuring small differences in topography on the tape winding surface 74. The waviness probe 80 measures and records data that is subsequently analyzed by commercially available surface analysis software to arrive at the WT quantity. In this regard, the WT is a measurement of the distance between the peaks and the valleys present on the tape winding surface 74. Small values of WT indicate the tape winding surface 74 is uniformly straight. Alternately, large values of WT indicate the tape winding surface 74 is uneven, which contributes to lateral movement and tension gradients in the storage tape 28 (FIG. 1).

In one exemplary embodiment, an average WT of the tape winding surface 74 is measured across three circumferentially-spaced locations. For example, and with reference to FIG. 4, the WT is measured at three circumferential locations along the tape winding surface 74 corresponding to 0 degrees, 120 degrees, and 240 degrees, as shown. With reference to FIG. 3, the waviness probe 80, for each of the three circumferential locations, is positioned adjacent to the tape winding surface 74 and traversed between the first end 76 and the second end 78 (i.e., between the top and bottom) of the hub 50. The waviness probe 80 measures the maximum surface value (the peak) at that circumferential location (for example at 0 degrees) between the first end 76 and the second end 78, and the minimum surface value (the valley) at that same circumferential location. The difference between the maximum surface value and the minimum surface value at that circumferential location is represented as the total waviness at that circumferential location in micro-inches. The average total waviness (i.e., average WT) is defined to be the average of the three total waviness measurements corresponding to the three circumferential locations described above. In accordance with the present invention, the hub 50 is provided with a straight tape winding surface 74 having an average WT of less than 1000 micro-inches, more preferably the average WT is less than 500 micro-inches, and most preferably the average WT of the tape winding surface 74 is approximately 150 micro-inches. In contrast, known plastic hubs exhibit a tape winding surface having an average WT of more than approximately 1100 micro-inches.

The concentricity of the tape winding surface 74 (and therefore the hub 50) can be measured by a radial total indicator run-out (TIR) probe 92 shown in ghost outline in FIG. 4. For example, the TIR probe 92 can be a height gauge available from Mitutoyo Measurement Technology, Warwick, U.K., although other commercially available height gauges can also be utilized. With reference to FIGS. 3 and 4, the TIR probe 92 is positioned in contact with the tape winding surface 74 at a point between the first end 76 and the second end 78. The hub 50 is rotated about the central axis 90. As the hub 50 rotates, the TIR probe 92 measures the radial total indicator run-out of the tape winding surface 74. The radial total indicator run-out quantifies the concentricity of the tape winding surface 74 with respect to the axis 90. For example, a radial total indicator run-out of 0 inches would indicate that the tape winding surface 74 describes a perfect circle having an axis centered at the axis 90. It is desired that the radial total indicator run-out be minimized. In one embodiment, the tape winding surface 74 has a radial total indicator run-out of less than 700 micro-inches. In a preferred embodiment, the tape winding surface 74 has a radial total indicator run-out of approximately 500 micro-inches. In contrast, known plastic hubs have tape winding surfaces that exhibit a radial total indicator run-out of approximately 2300 micro-inches.

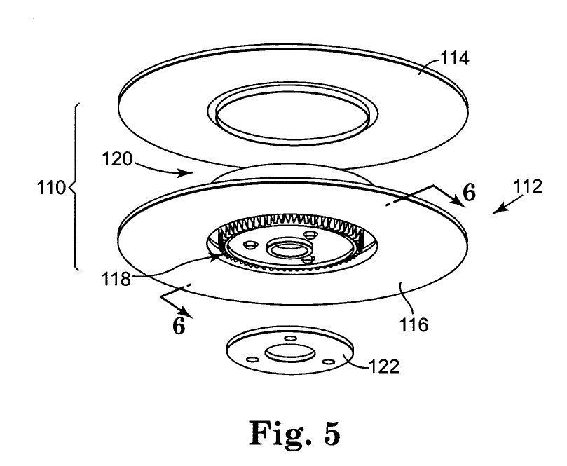

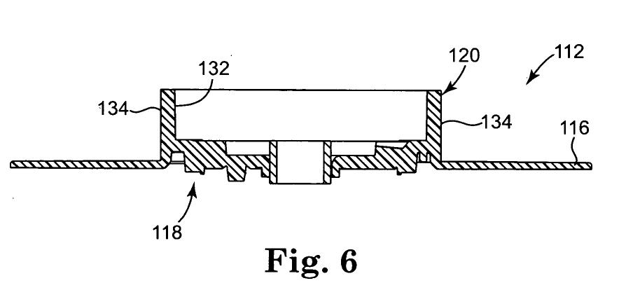

An alternative embodiment of a tape reel assembly 110 in accordance with the present invention is illustrated in FIGS. 5 and 6. FIG. 5 is a perspective view illustrating the tape reel assembly 110 as a two-piece assembly including a hub portion 112 and an upper flange 114. The hub portion 112 includes an integrally formed lower flange 116, driven teeth 118, and a hub 120. The driven teeth 118 can be formed as part of the lower flange 116. Alternately, the driven teeth 118 can be formed as part of the hub 120. In addition, the tape reel assembly 110 can include a metallic washer 122. The lower flange 116 can be molded about the washer 122, or the washer 122 can be separately assembled to the lower flange 116. In an alternate embodiment, the washer 122 is not utilized.

A cross-sectional view of the hub portion 112 in accordance with the present invention is illustrated in FIG. 6. As shown, the hub portion 112 includes the hub 120 and the integrally formed lower flange 116. The hub 120 defines an interior surface 132 and a tape winding surface 134.

The hub portion 112 is a microcellular foam structure utilizing any of the materials previously described with respect to the hub 50 (FIG. 2) and the related methods of manufacture. In a preferred embodiment, the hub portion 112 is formed of microcellular foam utilizing 20% glass-filled polycarbonate as the polymer and nitrogen as the blowing agent. The resulting microcellular plastic hub 120 has an average cell size of between 5 and 50 micrometers.

Formation of the hub portion 112 from microcellular foam permits the hub 120 to be thicker than a conventional hub and the tape winding surface 134 to be uniquely straight. In one embodiment, the thickness of the hub 120 is between 0.05 to 0.2 inch, more preferably the thickness of the hub 120 is between 0.07 to 0.125 inch, and most preferably the thickness of the hub 120 is approximately 0.1 inch.

In accordance with the present invention, the tape winding surface 134 is highly straight, having a WT averaged across three circumferential locations of less than 1000 micro-inches, as measured by the methods described above. In a preferred embodiment, the tape winding surface 134 has an average WT of less than 500 micro-inches. In a more preferred embodiment, the tape winding surface 134 has an average WT of approximately 150 micro-inches.

In addition, the tape winding surface 134 is highly concentric, having a radial total indicator run-out of less than approximately 700 micro-inches, as measured by the methods described above. In a preferred embodiment, the tape winding surface 134 is highly concentric and has a radial total indicator run-out of approximately 500 micro-inches.

### EXAMPLES AND COMPARATIVE EXAMPLES

The following examples further describe the tape reel assemblies of the present invention, methods of forming the tape reel assemblies, and the tests performed to determine their characteristics. The examples are provided for exemplary purposes to facilitate an understanding of the invention, and should not be construed to limit the invention in any way.

Hubs were constructed as described below, and quantified for total waviness (WT) and radial total indicator run-out (radial TIR). The WT was measured at three circumferential locations. With reference to FIG. 4, Location 1 was positioned at zero degrees, Location 2 was positioned at 120 degrees, and Location 3 was positioned at 240 degrees. A SV-3000 waviness probe was placed in contact with the tape winding surface and traversed between the first end and the second end of the hub in quantifying the waviness at that circumferential location, as illustrated in FIG. 3. An average total waviness (i.e., average WT) was calculated based upon the WT measurements at the three circumferential locations. The radial TIR was measured by a TIR probe placed as illustrated in FIG. 4. In particular, the TIR probe was positioned to contact the tape winding surface at a point between the first end and the second end of the hub. The hub was rotated about its central axis. As the hub rotated, the TIR probe measured the radial total indicator run-out of the tape winding surface.

### Example 1

A hub according to FIG. 3 was constructed of microcellular foam comprising 20% glass-filled polycarbonate as the polymer and nitrogen as the blowing agent. The 20% glass-filled polycarbonate material is identified as ML5369-739 available from GE Plastics, Pittsfield, Mass. The hub was injection molded to have a hub thickness of 0.070 inches in an injecting molding machine modified by the above-described MuCell® system. The total waviness (WT) of the hub of Example 1 was measured to be 130 micro-inches at Location 1, 140 micro-inches at Location 2, and 130 micro-inches at Location 3. Thus, the tape winding surface had an average WT of approximately 133 micro-inches. The radial TIR of the hub of Example 1 was not measured.

### Example 2

A hub according to FIG. 3 was constructed of microcellular foam comprising 20% glass-filled polycarbonate as the polymer and nitrogen as the blowing agent. The 20% glass-filled polycarbonate material is identified as ML5369-739 available from GE Plastics, Pittsfield, Mass. The hub was injection molded to have a hub thickness of 0.100 inches in an injecting molding machine modified by the above-described MuCell® system. The WT was measured at three locations. The WT of the hub of Example 2 was measured to be 150 micro-inches at Location 1, 60 micro-inches at Location 2, and 130 micro-inches at location 3. Thus, the tape winding surface had an average WT of approximately 113 micro-inches. The radial TIR of the hub of Example 2 was measured to be 500 micro-inches.

### Comparative Example 1

A hub according to FIG. 3 was constructed of 20% glass-filled polycarbonate material injection molded in a conventional process. The 20% glass-filled polycarbonate material is identified as ML5369-739 available from GE Plastics, Pittsfield, Mass. The hub thickness of Comparative Example 1 was 0.070 inches. The tape reel assembly of Comparative Example 1 was measured for WT and radial TIR. The total waviness of the conventional hub for Comparative Example 1 was measured at three locations. The WT was measured to be 750 micro-inches at Location 1, 1300 micro-inches at Location 2, and 1280 micro-inches at Location 3. Thus, the tape winding surface had an average WT of approximately 1110 micro-inches. The radial TIR of the conventional hub of Comparative Example 1 was measured to be 800 micro-inches.

### Comparative Example 2

A hub according to FIG. 3 was constructed of 20% glass-filled polycarbonate material in a conventional injection molding process. The 20% glass-filled polycarbonate material is identified as ML 5369-739, available from GE Plastics, Pittsfield, Mass. The hub of Comparative Example 2 had a thickness of 0.100 inches. The total waviness WT was measured at three locations. Specifically, the conventional hub of Comparative Example 2 had a WT of 2060 micro-inches at Location 1, 2400 micro-inches at Location 2, and 2560 micro-inches at Location 3. Thus, the tape winding surface had an average WT of approximately 2340 micro-inches. The radial TIR of the conventional hub of Comparative Example 2 was measured to be 2300 micro-inches.

As represented in Table 1 below, the inventive hubs of Example 1 and Example 2 formed of microcellular foam have highly straight tape winding surfaces as exhibited by the low average WT values and highly concentric tape winding surfaces as exhibited by the low radial TIR values.

TABLE 1

| | Conventional | | Conventional | |
|---|---|---|---|---|
| | hub | | hub | |
| | Comparative | Hub | Comparative | Hub |
| | Example 1 | Example 1 | Example 2 | Example 2 |
| Hub thickness T¹ | 0.070 | 0.070 | 0.100 | 0.100 |
| WT² Location 1 | 750 | 130 | 2060 | 150 |
| WT² Location 2 | 1300 | 140 | 2400 | 60 |
| WT² Location 3 | 1280 | 130 | 2560 | 130 |
| Average WT² | 1110 | 133 | 2340 | 113 |
| Radial TIR² | 800 | not | 2300 | 500 |
| | | measured | | |

¹thickness in inches
²units of micro-inches

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electromechanical, electrical, and computer arts will appreciate that the present invention can be implemented in a wide variety of embodiments. Specifically, a number of other tape reel assembly constructions other than those shown are within the scope of this invention. In particular, this application is intended to cover any adaptations or variations of tape reel assemblies having a hub formed of microcellular foam. Therefore, it is manifestly intended that this invention be limited only by the claims and the equivalents thereof.

In particular, while the tape reel assembly of the present invention has been described as being part of a data storage tape cartridge, other tape drive system applications are equally applicable. Thus, the tape reel assembly of the present invention can be provided as part of a tape drive and otherwise employed to wind and unwind storage tape within the drive. In addition, the tape reel assembly can be defined by the hub alone, or alternately, by the hub portion alone. In this regard, the upper and lower flanges described above are optional elements of the tape reel assembly, as is the washer.

1. A tape reel assembly for use in a tape drive system for winding and unwinding storage tape, the tape reel assembly comprising:
a plastic hub defining a tape winding surface;
wherein the hub is formed of microcellular foam.

2. The tape reel assembly of claim 1, wherein the microcellular foam is selected from the group consisting of microcellular polycarbonate foam, microcellular glass-filled polycarbonate foam, microcellular carbon-filled polycarbonate foam, microcellular styrene acrylonitrile foam, microcellular polystyrene foam, microcellular acrylonitrile butadiene styrene foam, microcellular acetal foam, microcellular nylon foam, microcellular poly-ether-ether-ketone foam, microcellular polyetheramide foam, microcellular polypropylene foam, microcellular polyethylene foam, and microcellular polyester foam.

3. The tape reel assembly of claim 1, wherein the microcellular foam has a cell size of between 5 and 50 micrometers.

4. The tape reel assembly of claim 1, wherein the tape winding surface has an average total waviness of less than 1000 micro-inches.

5. The tape reel assembly of claim 1, wherein the tape winding surface has an average total waviness of less than 500 micro-inches.

6. The tape reel assembly of claim 1, wherein the tape winding surface has an average total waviness of approximately 150 micro-inches.

7. The tape reel assembly of claim 1, wherein the tape winding surface has a radial total indicator run-out of less than 700 micro-inches.

8. The tape reel assembly of claim 1, wherein the tape winding surface has a radial total indicator run-out of approximately 500 micro-inches.

9. The tape reel assembly of claim 1, wherein the hub has a thickness of between 0.05 to 0.2 inch.

10. The tape reel assembly of claim 1, wherein the hub has a thickness of between 0.07 to 0.125 inch.

11. The tape reel assembly of claim 1, wherein the hub has a thickness of approximately 0.1 inch.

12. The tape reel assembly of claim 1, wherein the tape reel assembly further includes:
an upper flange; and
a lower flange, the upper and lower flanges coupled to and extending in a radial fashion from opposing ends of the hub.

13. The tape reel assembly of claim 12, wherein at least one of the upper flange and the lower flange is formed of microcellular foam.

14. A data storage tape cartridge comprising:
a housing defining an enclosed region;
at least one tape reel assembly rotatably disposed within the enclosed region and including:
a hub defining a tape winding surface; and
a storage tape wound about the tape winding surface;
wherein the hub is formed from a microcellular foam.

15. The data storage tape cartridge of claim 14, wherein the tape winding surface has an average total waviness of less than 500 micro-inches.

16. The data storage tape cartridge of claim 14, wherein the tape winding surface has an average total waviness of approximately 150 micro-inches.

17. The data storage tape cartridge of claim 14, wherein the tape winding surface has a radial total indicator run-out of less than 700 micro-inches.

18. The data storage tape cartridge of claim 14, wherein the tape winding surface has a radial total indicator run-out of approximately 500 micro-inches.

19. The data storage tape cartridge of claim 14, wherein the hub has a thickness of between 0.07 to 0.125 inch.
